(19) United States
(12) Patent Application Publication
(10) Pub. No.: US 2014/0339439 A1
(43) Pub. Date: Nov. 20, 2014

(54) Method for High-Resolution 3D Localization Microscopy

(71) Applicant: Carl Zeiss Microscopy GmbH, Jena (DE)

(72) Inventors: Joerg RITTER, Jena (DE); Joerg SIEBENMORGEN, Jena (DE); Thomas KALKBRENNER, Jena (DE)

(73) Assignee: Carl Zeiss Microscopy GmbH, Jena (DE)

(21) Appl. No.: 14/276,335

(22) Filed: May 13, 2014

(30) Foreign Application Priority Data
May 14, 2013 (DE) DE102013208927.9

(51) Int. Cl. G01N 21/64

(52) U.S. Cl. CPC G01N 21/6458
USPC 250/459.1

(57) ABSTRACT

A method for high-resolution 3D localization microscopy, in which sample is used which has a boundary surface on the imaging side. The sample is illuminated with excitation light in order to excite fluorescence markers to emit light. The sample is imaged to a still image along an imaging direction, by means of imaging optics. The still image contains images of the fluorescing fluorescence markers. The imaging optics has a focal plane and an optical resolution. The excitation and imaging steps are repeated multiple times so that multiple still images are obtained. The excitation steps create images of at least a subset of the fluorescing fluorescence markers isolated in each of the still images. A location is determined in each of the still images and this location has a precision which is greater than the optical resolution. A high-resolution composite image is generated from the locations determined in this manner.

### RELATED APPLICATIONS

The present application claims priority benefit of German Application No. DE 10 2013 208 927.9 filed on May 14, 2013, the contents of which is incorporated by reference in its entirety.

### FIELD OF THE INVENTION

The invention relates to a method for high-resolution 3D localization microscopy, wherein a sample is used which has a boundary surface on the imaging side thereof, the sample is illuminated with excitation light in an excitation step in order to excite fluorescence markers in the sample to fluoresce, in an imaging step the sample is imaged to a still image along an imaging direction by means of an imaging optics, wherein the still image contains images of the fluorescing fluorescence markers and the imaging optics has a focal plane and an optical resolution, and the excitation step and the imaging step are repeated multiple times such that multiple still images are produced in this way, wherein the excitation steps are carried out in such a manner that the images of at least a subset of the fluorescing fluorescence markers are isolated in each of the still images, in each of the multiple still images produced from the isolated images of the fluorescing fluorescence markers a location is determined for the corresponding fluorescence marker, and this location has a precision which is greater than the optical resolution, and a high-resolution composite image is generated from the locations determined in this manner

### BACKGROUND OF THE INVENTION

Various different methods have been developed in the prior art to overcome the diffraction limit in microscopy. A method, abbreviated as PALM (photo-activated localization microscopy), is known from WO 2006/0127692 and DE 102006021317 A1, which uses a marking substance to image a sample, wherein said marking substance can be activated by means of optical radiation. The marking substance can only emit specific fluorescent radiation in the activated state. Inactivated molecules of the marking substance do not emit fluorescence radiation—or at least no noticeable fluorescence radiation—with the specific characteristics, even after radiation with excitation light. For this reason, the excitation light is generally termed the switching signal. In the PALM method, the switching signal is applied in such a manner that at least some of the activated marking molecules are spaced apart from neighboring, activated marking molecules in such a manner that they are separated on the scale of the optical resolution of the microscope, or can be subsequently separated by image processing methods. One says that fluorescence markers are isolated, and terms this step the isolating step. The sample is imaged as follows: a still image of the sample is obtained, wherein at least a few fluorescence markers fluoresce in isolation. Next, the center of the registered radiation distribution is determined for each fluorescence marker, which is, of course, not a focused point—due to the limit of the resolution. In this manner, the location of the fluorescence marker is determined with higher precision, using computation, than the optical resolution actually allows. This step is termed the localization step.

The isolation step and localization step are carried out in repetition, such that multiple still images are obtained. Each fluorescence marker is ideally isolated at least one time in at least one still image. The locations determined from the still images make it possible to generate a composite image which contains each of the locations of the individual fluorescence markers with a precision greater than the optical resolution. Such an image with precision which is enhanced to greater than the optical resolution is called a high-resolution image.

To isolate the fluorescence markers, the PALM principle exploits statistical effects. For a fluorescence marker which can be stimulated to fluorescence by the switching signal at a given intensity, it is possible to adjust the intensity of the switching signal so that the probability of activating fluorescence markers present in a given area of the sample is so small that there is a sufficient number of sub-regions in the imaged sample in which at least several isolated fluorescence markers can be simulated to emit fluorescence light within the optical resolution. The simulation of the sample activated in such a manner then leads to fluorescence markers which fluoresce in isolation.

The PALM principle has been further advanced with regards to the activation—that is, the application of the switching signal. By way of example, for molecules which have a long-lived non-fluorescing state and a short-lived fluorescing state, a separate activation using activation light which is different in spectrum from the excitation light is not at all necessary. Rather, the sample is first illuminated with high-intensity excitation light in such a manner that the overwhelming majority of the molecules are brought into the long-lived state where fluorescence is not possible (e.g. a triplet state). The remaining molecules which are still fluorescing are then at least partially isolated.

The PALM principle has also been given other abbreviations in the technical literature, such as STORM, for example. In this description, the abbreviation PALM is used to identify all microscopy techniques which achieve high-resolution by first isolating and localizing fluorescence markers. The PALM method has the advantage of not needing precise localization for the excitation. Simple wide-field illumination is sufficient.

The PALM principle achieves high resolution in 2D and/or lateral—meaning perpendicular to the imaging direction—because the localization can also be performed for fluorescence markers which are isolated in a plane which is perpendicular to the imaging direction in projection. Fluorescent markers which lie one behind the other along the direction of imaging—meaning in the depth dimension—cannot be differentiated using the PALM principle per se. The first experimental implementations of the PALM method therefore used TIRF illumination to ensure that only fluorescence markers from a sharply defined depth range—which is significantly shallower than the depth of field of the imaging optics being used—are excited. No depth resolution, in the sense of assignment of fluorescence markers to different depth positions, took place.

However, since this time, the prior art has introduced further methods and approaches which achieve 3D localization microscopy wherein fluorescence markers are also isolated and localized in the third spatial dimension—with respect to the imaging in the depth dimension.

The publication by Shtengel, et al, PNAS 106, Page 3125, 2009 takes another approach. In this publication, photons which are emitted by the fluorescing fluorescence markers are caused to interfere with themselves. For this purpose, two lenses which are assembled in the 4π configuration are used to simultaneously observe the fluorescing fluorescence markers. By means of a special, 3-way beam splitter, the radiation is made to achieve interference using the resulting, divided beam paths. Each of the resulting images are detected by a camera, and the proportional intensities of the images provide information on the depth positions.

In the publication Toprak et al., Nanolet. 7, Pages 3285-3290, 2009, as well as according to Juette et al., Nature Methods 5, Page 527, 2008, a 1:1 beam splitter is installed in the optical imaging path which splits the image of the sample into two partial images which can be detected independently. In addition, an optical path length difference is inserted into one of the partial beam paths downstream of the beam splitter in such a manner that the two partial beam paths image two object planes which are spaced apart from each other in the depth dimension by half of the minimum optical resolution, or by the whole minimum optical resolution. The depth position of a fluorescence marker which lies between these two object planes is obtained from an analysis of the two partial images of this fluorescence marker (e.g. as far as the width of the point spread is concerned). The method requires two highly resolved partial images and a superimposition of these two partial images with sub-pixel precision. One implementation of this approach which drastically reduces the complexity of alignment is known from DE 102009060490 A1.

A principle for obtaining depth information in 3D localization microscopy is found in DE 102010044031 A1. This principle uses so-called light sheet illumination for the excitation and/or switching light, as described, by way of example, in the publication P. Keller and E. Stelzer, “Quantitative In Vivo Imaging of Entire Embryos with Digital Scanned Laser Light Sheet Fluorescence Microscopy”, Current Opinion in Neurobiology, 2009, Vol. 19, Pages 1-9. The samples are illuminated is alternation by two light sheets which are displaced axially with respect to each other, but overlap. Molecules which emit fluorescence radiation in both light sheet positions must logically lie in the region of overlap of the two light sheet positions. For this reason, a suitable filtering is performed. In this way, the selection of the depth can be much more precise than the thickness of the light sheet. The thickness of the region of overlap is relevant to the filtering. The disadvantage of this approach is that it is necessary to capture twice the number of still images for the localization—particularly for each light sheet position—than would be required in conventional PALM imaging. In addition, the precise adjustment of the displacement of the light sheets, and particularly the reproducibility of the shift, is essential for the thickness of the region of overlap, and therefore for the depth resolution. Finally, there can generally be no useful resolution inside the region of overlap which is filtered out.

The publication B. Huang et al., Science 319, page 810, 2008 describes an imaging beam path for the PALM principle in which lies a weak cylindrical lens which leads to a specific astigmatic distortion in the image. As a result, the image of each fluorescence marker on the camera is elliptically distorted as soon as the fluorescence marker is positioned above or below the focal plane. Information on the depth position of the fluorescing fluorescence marker can be obtained from the orientation and the degree of the distortion. A disadvantage of this method is that, where a molecular dipole is present, the local environment and orientation thereof can lead to distortion of the image of the fluorescing fluorescence marker, and this distortion nevertheless has nothing to do with the depth position. Such fluorescing fluorescence markers therefore are given a false depth value, depending on their spatial position.

A further principle for depth resolution in localization microscopy is used in the intentional distortion of the point spread function (also abbreviated as PSF below) of the image. Such an approach is described in WO 2012/039636, by way of example, wherein the imaging of the sample is modified in such a manner that the resulting image distortion depends on depth positions. By way of example, the point source function is modified into a type of helical structure, such that for the imaging of a fluorescing point, rather than a diffraction spot, two lobes positioned next to each other are formed, wherein the relative position thereof—for example the rotary position—depends on the depth position of the imaged, fluorescing point.

In PAL microscopy, an undesirable illumination of the fluorescence marker can be disadvantageous, because the fluorescence marker can often only undergo a very limited number of activation and/or excitation cycles. In this context, every illumination which is not used for high-resolution imaging is undesirable.

The distortion of the point spread function is disadvantageous as far as the localization of the fluorescence marker is concerned. On the one hand, the complexity of calculations to isolate the center of the distorted image of a fluorescence marker increases. On the other hand, it may be the case that images of fluorescence markers can no longer be separated, which could still be separated if the PSF was not distorted—i.e. was ideal. As a result, in some circumstances it may be necessary to make more still images, such that the fluorescence markers are illuminated in a manner which is actually undesirable.

### SUMMARY OF THE INVENTION

Therefore, the problem addressed by the invention is that of providing a method for PAL microscopy which enables three-dimensional high resolution, and minimizes the illumination of the fluorescence markers as much as possible. In addition, the complexity of calculations for the localization of the fluorescence markers should be kept as low as possible.

The problem is solved according to the invention by a method of the type named above, which is characterized in that the imaging optics is adjusted in such a manner that the focal plane is above the boundary surface, and in the still image the isolated images of the fluorescing fluorescence marker are analyzed for the size thereof, and data is derived from this regarding a depth position, which indicates how far below the boundary surface the corresponding fluorescing fluorescence marker is positioned along the imaging dimension.

In this description, a fluorescence marker is understood to mean a fluorescence emitter which is suitable for localization microscopy—that is, can be used for the purpose of causing individual fluorescence markers to fluoresce in isolation with respect to the optical resolution. The term “fluorescence marker” in this case is intended to include cases in which structures in a sample are marked with corresponding substances, and also cases in which the sample already inherently has the suitable properties of fluorescence.

The invention takes advantage of the fact that, even in an ideal, diffraction-limited imaging of the fluorescing fluorescence markers, the size of each image depends on the distance from the focal plane of the image. Within the focal plane, the smallest possible image is obtained—at the diffraction-limited spot. Moving away from the focal plane, fluorescence markers are then above or below the focal plane, and the image is larger. The direction—meaning whether a fluorescing fluorescence emitter lies above or below the focal plane—cannot be derived from the size of the image per se, and this is the reason for asymmetric distortions in the point spread function in the prior art.

The invention therefore suggests that the focal plane be intentionally placed above the boundary surface of the sample. No fluorescence markers are found in this position. Therefore, it is clear that all fluorescence emitters are below (with respect to the imaging direction) the boundary surface of the sample. The size of the image of a fluorescing fluorescence emitter therefore not only indicates the distance from the focal plane, but also the direction. The inherent symmetry is therefore broken.

As a result of this simple approach, the invention is able to obtain depth information for fluorescing fluorescence markers without the need to modify the point spread function of the image, and without the absolute necessity of a complex illumination process (for example, light sheet illumination).

Rather, the approach according to the invention can even employ a normal wide field illumination through the lens used for the imaging, in order to cause fluorescence markers to fluoresce in isolation. Of course, a light sheet can optionally be used for the illumination.

The direction information is obtained by the focal plane lying in a region where there is no sample. Therefore, for samples which are not covered by a cover plate, the focal plane is positioned above the sample surface, and therefore outside of the sample. If a sample is used which is covered with a cover plate, the focal plane can be moved into the cover plate. If a sample is used which is positioned in a cuvette, the focal plane can be positioned in the base of the cuvette. What is essential is that it is in a region which is positioned beyond a boundary surface of the sample (as seen in the direction of the imaging). Where the terms “above” and “below” are used in this context, this usage should not be construed as a limitation on a certain orientation of the microscope or the sample. Rather, the terms should be understood as a continuous relation with respect to the direction in which the sample is imaged. As such, areas above the focal plane are regions which lie between the focal plane and the imaging optics. Areas which are under the focal plane are therefore positioned such that the focal plane lies between these regions and the imaging optics.

The invention analyzes the size of the images of the fluorescence marker fluorescing in isolation to obtain axial location information. The particular images which have the smallest sizes are directly underneath the boundary surface. They can be used as reference values for the determination of distance. Therefore, in one implementation, it is preferred that the size of the images are taken in relation to the smallest size which appears in the still images. This smallest size characterizes the axial position of the boundary surface.

In one embodiment which particularly simplifies calculations, the size of an image can be analyzed by determining the surface area. For the surface area calculation, a minimum intensity value can be set in order to determine the boundary of the image. The surface area is linked to the depth—meaning the distance from the surface of the sample. The link as used can be saved in a table or can satisfy a function, wherein the table or function has been previously determined experimentally using a sample with a known depth structure. If this approach is combined with the approach described above, wherein the smallest size in the images is taken into account, this smallest size serves the purpose of determining the starting position in the table or in the functional relationship. In one particularly preferred embodiment, the relationship indicates the relative depth position with respect to the surface of the sample as a function of the difference between the determined size and the smallest size.

As an alternative to surface area, a maximum dimensional measurement, or a minimum cross-section of the image, can be used as an indication of the size.

A particularly precise analysis of the size takes into account the point spread function of the image. This point spread function can be determined experimentally as has been previously described in the prior art, by the determination of the image of a point emitter. This can be performed experimentally or by modelling, giving a volume into which the light of the point emitter is scattered. A sectional plane is then located in this point spread function which is the best approximation of the image of an actual fluorescing fluorescence marker. The position of the sectional plane indicates the depth position. The x, y coordinates can optionally be determined in this manner as well.

An equivalent approach to this is the shifting of the point spread function in the image plane of the still image in such a manner that the sectional plane of the point spread function obtained as a result has the best agreement with the image of the observed fluorescing fluorescence marker. In this way, not only is it possible to determine the depth position of the fluorescence marker, but also optionally the x, y coordinates—because the position where the point-shaped fluorescence emitter must be found within the volume is known from the previous determination of the point spread image. This previously known center of the point spread image is then the position of the observed fluorescence emitter in three coordinates, with a resolution which is significantly higher than the diffraction limit actually allows.

For the image analysis, the same algorithms are used as are used in the prior art for localization.

### BRIEF DESCRIPTION OF THE DRAWINGS

The invention is described below in greater detail with reference to the drawings and in an exemplary manner, wherein:

FIGS. 1a and b are schematic illustrations of an activated marker molecule in a volume limited in resolution;

FIG. 2 is a schematic illustration of the imaging of different activated and non-activated marker molecules on a spatial detector,

FIG. 3 is a process diagram for the generation of an image in the PALM method,

FIG. 4 shows explanatory illustrations of marker molecules imaged on the detector in FIG. 2, corresponding to the process diagram in FIG. 3,

FIG. 5 is a schematic illustration of a microscope for PAL microscopy, and

FIG. 6 is a section of the imaging of a sample for depth resolution.

### DESCRIPTION OF THE EMBODIMENTS

Elements which correspond functionally or structurally in the different figures are indicated with the same reference numbers throughout, in order to avoid repetition in the description.

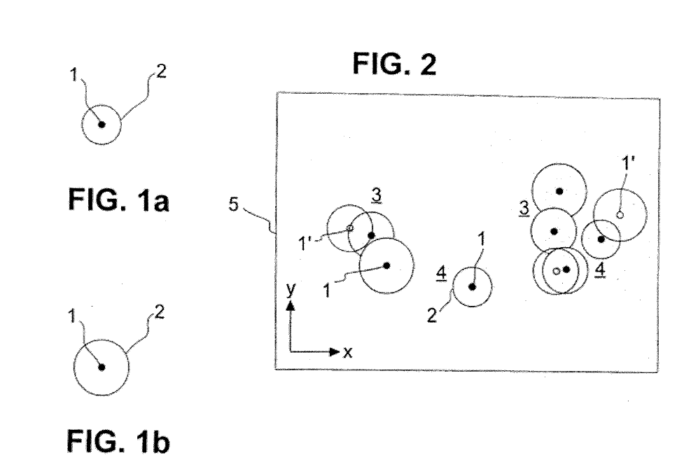

FIG. 1a schematically illustrates a marker molecule 1 which has been excited to fluorescence. The fluorescing marker molecule 1 can only be detected with a limited optical resolution in a microscope, due to physical laws. Even if the microscope reaches the diffraction limit of the optical resolution, the photons of the fluorescing marker molecule 1 are still scattered due to diffraction, and the marker molecule 1 is detected as a diffraction spot 2. The microscope therefore must reproduce a larger object, as the image, than the geometric expansion of the marker molecule 1 as indicated in FIG. 1 schematically as a black circle. This is shown in FIG. 1 by the diffraction spot 2. The size of the diffraction spot 2 depends on the quality of the microscope device used, and is defined by the half-value width of the point spread function of the optical image. However, the lens used need not necessarily work at the diffraction limit, even if this is preferred. The size of the image—i.e. the diffraction spot 2—also depends on the focus. If the imaged marker molecule 1 is not exactly in the focal plane, the diffraction spot 2 is larger, as shown in FIG. 1b.

At this point, to make it possible to more precisely localize the marker molecule 1 inside the diffraction spot 2, the PALM method as generally described above is used. This activates individual marker molecules. In this description, the term “activation” very generally means the activation of certain luminescence properties of the marker molecules—that is, both the switching-on of luminescent excitability and modification of the luminescence spectrum which corresponds to the switching-on of certain luminescence properties. In the embodiment described here, the activation is achieved by optical activation light. However other—and particularly non-optical—activation mechanisms are possible.

At this point, the activation is carried out in such a manner that there are at least some activated molecules which can still be differentiated, at least barely, within the optical resolution. These are isolated marker molecules.

FIG. 2 is a schematic top view of an exemplary situation in a still image 5. The still image 5 is illustrated in the x/y plane which is perpendicular to the optical axis of the image. As can be seen, there are regions 3 in which the diffraction spots 2 of neighboring marker molecules overlap. However, in this case, as can be seen in the region 3 on the left in FIG. 2, only the marker molecules 1 which have been previously activated are relevant. Non-activated marker molecules 1′ do not emit the particular fluorescence light which has been captured for the still image 5. Therefore, they have no role to play.

In several regions, for example the region 4 in the center of the still image 5, marker molecules 1 are positioned such that their diffraction spots 2 do not overlap with any diffraction spot of another activated marker molecule 1. The right side of the still image 5 shows that regions 3 in which diffraction spots of activated marker molecules overlap, can certainly neighbor on regions 4 in which this not the case. The region 4 at right again additionally shows that the proximity of an activated marker molecule 1 to a non-activated marker molecule 1′ does not play any role in the detection, because such a marker molecule 1′ does not emit the fluorescence light which is relevant to the still image 5—that is, it does not fluoresce.

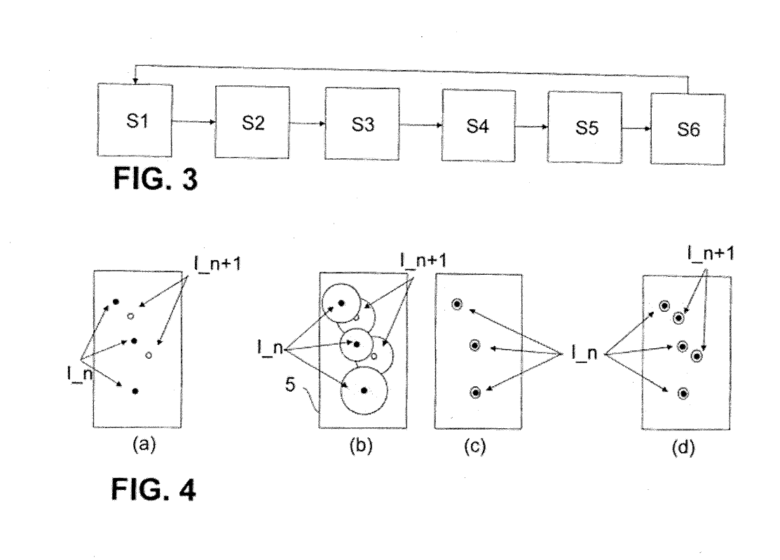

The steps illustrated schematically in FIG. 3 are used at this point to capture an image which is more detailed than the optical resolution fixed by the mechanism. In the context of this description, this is a high-resolution image.

In a first step S1, a subset of the marker molecules is activated by means of a switching signal; the subset is switched from a first state in which the molecules cannot be excited to emit the specific fluorescence light to a second state in which they can be excited to emit the specific fluorescence light. Of course, the activation signal can also cause a selective deactivation. That is, in step S1, the opposite procedure can also be used. What is essential is that only a portion of the marker molecules can be excited to emit the specific fluorescence light following step S1. The activation and/or deactivation (for reasons of simplicity, only the case involving activation is described below) occurs according to the marker molecules used or the inherently fluorescent sample molecules. In the case of a dye such as DRONPA, PA-GFP, or reversibly switchable synthetic dyes (such as Alexa/Cyan constructs), for example, the activation occurs by optical radiation. Therefore the switching signal is switching light.

FIG. 4, shown under FIG. 3, shows the state following step S1, in drawing a. Only a subset of the marker molecules is activated. These marker molecules constitute a set 1_n, and are illustrated as a solid black dot. The remaining marker molecules have not been activated in this step. This set is indicated in drawing a of FIG. 4 by 1_n+1. Fluorescing proteins known in the prior art, such as PA-GFP or DRONPA, are preferably used as the fluorescence dye. The activation of such molecules is performed with light in the region of 405 nm, the excitation to emit fluorescence light occurs at a wavelength of approximately 488 nm, and the fluorescence light is in a region above 490 nm.

So that the fewest possible diffraction spots overlap in the set 1_n, in which case the marker molecules could not be differentiated, the activation is adjusted in such a manner that the greatest number of marker molecules in the set 1_n are isolated with respect to the volume which can be resolved with the optical apparatus.

In a second step S2, the sample is excited to emit fluorescence light. In the process, all marker molecules which have been activated are made to fluoresce.

In a third step S3, the fluorescence light emitted as a result is detected, for example by integration of the captured fluorescence photons, such that the situation results for the still image 5 which is illustrated in FIG. 4 in the drawing b below. As can be seen, the diffraction spots 2 of all of the fluorescing marker molecules 1 ideally do not overlap. Therefore, all of the activated marker molecules 1 are isolated. The size of the diffraction spots is determined by the optical resolution of the image and the depth position of the marker molecules. In addition, (theoretical) diffraction spots of fluorescence markers are drawn into the drawing b in FIG. 4, and these belong to the non-activated set 1_n+1. Because these non-activated marker molecules do not emit any fluorescence light, no fluorescence light from their (theoretical) diffraction spots disrupts the detection of the fluorescence light from the set 1_n of the fluorescing marker molecules.

Of course, there can also be marker molecules 1 in the set 1_n of the activated marker molecules 1 which are not isolated. These non-isolated marker molecules 1 are not included in a localization. For this purpose, in a subsequent step S4, a filtering is performed in the set 1_n of the activated marker molecules 1 which identifies the fluorescing marker molecules 1 which are isolated with respect to the resolution of the image. This means that the diffraction spots 2 can optionally be separated by means of computational methods. The separation is possible if it is possible to determine whether a diffraction spot 2 is caused by a fluorescing marker molecule 1 or by multiple fluorescing marker molecules 1. For the localization, only the specific fluorescing marker molecules 1 are used which were able to be identified in the filtering as isolated. In the fourth step S4, the position of the isolated, fluorescing marker molecules is further determined by calculation from the diffraction distribution fluorescence spots. The resolution with which the position of the isolated marker molecules 1 is known is sharpened beyond the resolution of the optical apparatus, as shown in drawing c in FIG. 4. Drawing c only shows the location in the x/y plane. The z-coordinate—meaning the location along the depth dimension, is addressed further below.

A fifth step S5 then adds the locations for the marker molecules which have been localized into an image which has a resolution which is greater than the optical resolution. However, the image only includes information on the previously activated subset of the marker molecules.

In a sixth step S6, the image is made into a composite image. Next, the process jumps back to step S1, wherein the previously fluorescing molecules are once again deactivated. A deactivation can be achieved, depending on the type of marker molecule, by a separate illumination, or by the fading of the activated state. It is also possible to bleach out marker molecules which have already been imaged using excitation light.

By running through the steps, a further image is obtained which contributes to the composite image. In the next run-through, other marker molecules are (also) isolated and localized—for example the set 1_n+1 illustrated in FIG. 4.

The composite image is constructed by multiple run-throughs of steps S1 to S6, from images resulting from each run-through. These provide the locations of the marker molecules 1 with a resolution which is sharpened compared to the resolution of the optical image. Therefore, an appropriate number of iterations successively constructs a high-resolution composite image.

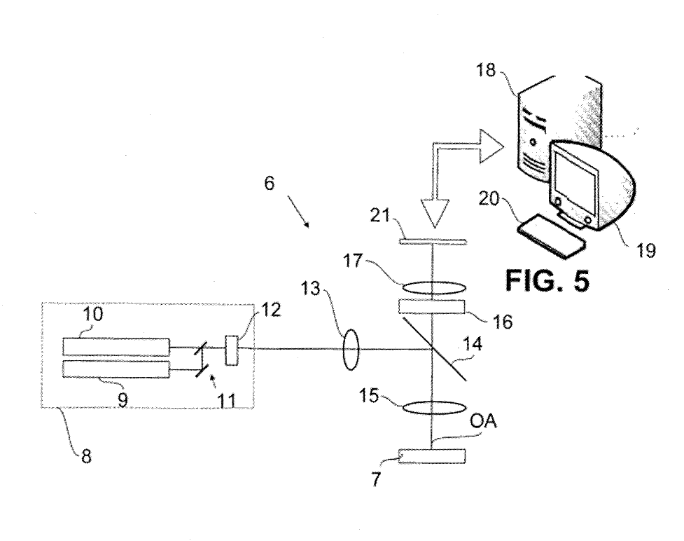

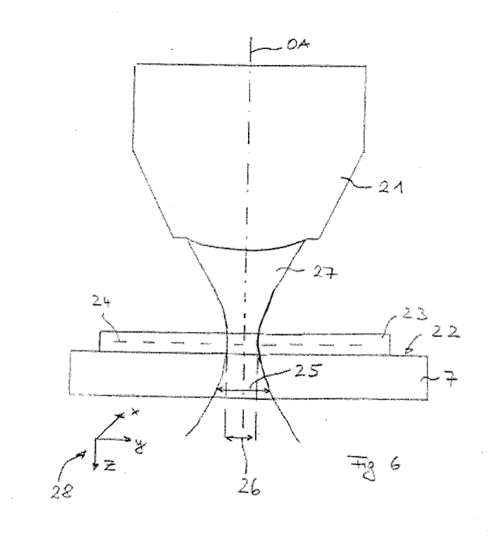

FIG. 5 schematically shows a microscope 6 for the high-resolution imaging of a sample 7. The microscope 6 is designed to carry out the PALM method. The sample 7 is imaged by a lens 15 in wide field on a detector 21. The lens 15 in this case fixes a focal plane which is bounded by a focal depth region, in the known manner, which depends on the concrete construction of the lens 15.

The sample 7 is marked, by way of example, with the dye DRONPA (see WO 2007009812 A1). The microscope 6 has a radiation source 8 for the purpose of activation and of exciting fluorescence, said radiation source 8 having individual lasers 9 and 10 with beams which are merged together via a beam combiner 11. The lasers 9 and 10 can emit radiation at 405 nm (the activation light) and 488 nm (for exciting fluorescence and for deactivation), by way of example. Dyes are also known (e.g. the dye by the name of DENDRA (cf. Gurskaya et al., Nature Biotech., Vol. 24, p. 461-465, 2006), wherein the activation and the excitation of fluorescence can take place at one and the same wavelength. In this case, a single laser is sufficient.

It is only an example, and not limiting in nature, that the activation and the excitation are carried out with radiation of different wavelengths. This can also be different—as has been described above in the introductory part of the description using the example of marker molecules which have a long-lived non-fluorescing state and a short-lived fluorescing state. As a result, the activation light and the excitation light are optionally the same wavelength, and differ in the time point when they are used and the intensity of the radiation. The radiation source 8 of the microscope 6 then only needs the means for one wavelength. By way of example, the laser 10, the beam combiner 11, and the filter 12 can be dispensed with.

In operation with two or more wavelengths, the acoustic-optical filter 12 serves the purpose of wavelength selection and rapid switching or damping of individual laser wavelengths. An optics 13 focuses the radiation via a dichroic beam splitter 14 into a pupil of a lens 15, such that the radiation of the radiation source 8 arrives at the sample 7 as wide field illumination.

Fluorescence radiation created in the sample 7 is collected via the lens 15. The dichroic beam splitter 14 is designed in such a manner that it allows the fluorescence light to pass, such that the light continues through a filter 16 to a tube lens 17, such that overall the fluorescing sample 7 is imaged on the detector 21.

A control device is included for the purpose of controlling the operation of the microscope 6. In this case, it is designed as a computer 18 with a display 19 and keyboard 20. The method steps S2 to S6 are carried out in the control device—that is, the computer 18. In this case, the frame rate of the matrix detector determines the total measurement time, such that a matrix detector 5 which has the highest possible frame rate is advantageous for reducing the measurement time.

The described method creates a composite image using the microscope 6, said image having a spatial resolution which is greater than the optical resolution of the microscope by a factor of, by way of example, 10. The optical resolution of the microscope 6 can be, by way of example, 250 nm laterally and 500 nm axially.

FIG. 1 shows the diffraction spot 2 of an imaged marker molecule 1 in a two-dimensional illustration. The depth position of the marker molecule is relevant for the size of the image of the marker molecule 1. FIG. 6 shows this situation. The figure shows a schematic cross-sectional view of the sample 7 imaged by the lens 21 along an optical axis OA. The depth coordinate of the image runs along the optical axis OA. This is the z-coordinate of a coordinate system 28 drawn schematically in FIG. 6. The coordinates x, y perpendicular to the same span the plane in which the image of the diffraction spots 2 were illustrated in FIGS. 1 and 2. The image produced by means of the lens 21 has a focal plane 24 with a depth of field around the same. This is due to the fact that the imaging produces a beam waist 27. This determines the size of the diffraction spot 2. As can be easily seen, the size of the diffraction spot varies according to the depth position—meaning the z-coordinate along the optical axis OA. In optimal conditions, the diffraction spot 2 is circular, and the relevant measure of size which varies with the z-coordinate is the diameter 25. As a matter of principle, the beam waist diameter 27, which lies within the region of the focal plane 24, cannot be reduced.

For this reason, it is possible to furnish the diameter and/or the size of the diffraction spot 2 as a measure for the depth position—meaning the z-coordinate. However, as can clearly be seen in FIG. 6, the result of the beam waist 27 is that the size of the diffraction spot increases as the distance from the focal plane 24 increases. The size itself does not provide any information on the direction in which a fluorescing marker molecule is distanced from the focal plane 24.

The sample 7 has an upper sample side 22 which has been covered by a cover plate 23 in the exemplary drawing in FIG. 6 (the thickness proportions are in no way to-scale). Therefore, to resolve the depth in the PALM method described above, the focal plane 24 is deliberately set above the upper sample side 22—for example in the cover plate 23. This measure has the result that there cannot be two fluorescing marker molecules which lie at an identical distance from the focal plane 24, but in a different direction. The size of the diffraction spot enables a discrete assignment of the z-coordinate. Therefore, in step S4, the size of the diffraction spot 2 is also evaluated. The center of the diffraction spot 2 provides the coordinates in the x, y plane. The size provides the z-coordinate. By way of example, the larger the diameter 25 of the diffraction spot 2 is, the larger the distance from the focal plane 24 is. In one embodiment, the z-position of the focal plane 24 is known, for example from a different measurement or from operating parameters of the microscope. The z-coordinate of the fluorescing, isolated marker molecule 1 is then referenced to this z-position. In this way, an absolute determination is made.

In another, preferred embodiment, a relative measure is obtained with respect to the upper side of the sample 22, by the diffraction spot 2 which has the smallest diameter 26 being found in the still images 5. The marker molecule 1 thereof must necessarily lie directly on the upper sample side 22. The depth of the marker molecule 1 localized in three dimensions is then given relative to the upper sample side by a measure for the z-distance of the fluorescing, isolated marker molecule 1 in question from the upper sample side 22 being determined from the difference between the smallest diameter 26 and the current diameter 25 of a fluorescing marker molecule 1.

FIG. 6 shows that the focal plane 24 is positioned inside a cover plate 23, as an example. This is not absolutely necessary. It is sufficient if it can be ascertained with certainty that the focal plane 24 is arranged outside of the sample 7. FIG. 6 likewise shows that the imaging by means of the microscope 15 proceeds from above toward the position of the upper sample side 22. However, an inverted construction is equally possible. The term “upper sample side” should therefore not be any kind of specification for the orientation of the sample 2—either absolutely, or in relation to the lens 15.

In the construction shown in FIG. 6, the illumination with the activation light and the excitation light occurs through the lens 15. This also not absolutely necessary. The only thing which is essential is that the imaging by means of the lens 15 is carried out in such a manner that the focal plane 24 is outside of the sample 7. The illumination of the sample, particularly the activation and/or the excitation, can also occur in another direction—for example by a light sheet applied substantially perpendicular to the optical axis OA or by a TIRF-like illumination as described, by way of example, in Tokunaga, Nature Methods 5, page 259 ff., 2008, wherein this is called a “highly inclined and laminated optical sheet”.

The description above mentions marker molecules when discussing fluorescence emitters. This term should not be taken as limiting in nature, and rather merely serves as an example for molecules, molecular complexes, proteins, or other protein structures which are present in the sample and which have suitable fluorescence emitter properties. Marker molecules can therefore be components which are retroactively added to the sample during a sample preparation step, and also elements which are inherently present in the sample. Corresponding sample preparations for the PALM method are known in the prior art.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A method for high-resolution 3D localization microscopy, wherein a sample is used which has a boundary surface on the imaging side thereof, comprising
illuminating said sample, in an excitation step, with excitation light in order to excite fluorescence markers in the sample to emit light,
imaging said sample, in an imaging step, to a still image along an imaging direction, by means of imaging optics, wherein the still image contains images of the fluorescing fluorescence markers, and wherein the imaging optics has a focal plane and an optical resolution,
repeating said excitation and imaging steps multiple times such that multiple still images are produced, wherein said multiple excitation steps are carried out in such a manner that images of at least a subset of the fluorescing fluorescence markers are isolated in each of the still images,
determining a location in each of the multiple still images produced from the isolated images of the fluorescing fluorescence markers, for the corresponding fluorescence marker, said location having a precision greater than the optical resolution,
generating from said locations a high-resolution composite image,
adjusting the imaging optics in such a manner that the focal plane is above the boundary surface,
analyzing the isolated images of the fluorescing fluorescence markers in the still images for their size, and
deriving information on a depth position from the size, which indicates how far the corresponding fluorescing fluorescence markers lie below the boundary surface along the imaging dimension.

2. The method according to claim 1, wherein the isolated images of the fluorescing fluorescence marker which have the smallest size are located, and the depth position of these fluorescence markers is indicated as lying on the boundary surface.

3. The method according to claim 2, wherein for the isolated images of the fluorescing fluorescence marker which have a size greater than that of the smallest size, the depth position thereof is indicated with respect to the boundary surface.

4. The method according to claim 1, wherein the excitation light is applied as a light sheet.

5. The method according to claim 1, wherein the imaging optics has a lens, and the excitation light is applied through the lens.

6. The method according to claim 5, wherein the excitation light is applied as wide-field illumination.

7. The method according to claim 1, wherein the sample is covered with a cover plate, and the imaging optics is adjusted in such a manner that the focal plane lies in the cover plate.

8. The method according to claim 1, wherein the images are analyzed with respect to their size, wherein a surface area and/or a maximum or minimum dimension of the image is determined and is used as a measure for the size.

9. The method according to claim 1, further comprising and analyzing a point spread function is analyzed from previously determined experimental data or a model, wherein a point spread image of a point-shaped, fluorescing element is determined, and the point spread image is shifted in the imaging direction until a sectional plane of the point spread image gives the best possible agreement with the image of the corresponding, fluorescing fluorescence marker.
